(19) United States
(12) Patent Application Publication
(10) Pub. No.: US 2006/0198408 A1
(43) Pub. Date: Sep. 7, 2006

(54) Method of restoring setting values by managing pon network topology table in device accommodating plurality of EPON ports

(75) Inventors: Jae-Sung Park, Gunpo-si (KR); Chang-Sup Shim, Seoul (KR); Yun-Je Oh, Yongin-si (KR); Do-You Jung, Yongin-si (KR); Hye-Young Park, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/359,850

(22) Filed: Feb. 22, 2006

(30) Foreign Application Priority Data
Feb. 22, 2005 (KR) 2005-14671

(51) Int. Cl. H01S 3/00

(52) U.S. Cl. 372/38.02

(57) ABSTRACT

A method of restoring setting values by managing a passive optical network (PON) network topology table in a device accommodating a plurality of Ethernet passive optical network (EPON) ports includes the steps of: booting the device accommodating a plurality of EPON ports; a controller for restoring a previously set configuration and PON network topology table from a backup memory of the device; and performing a module initialization operation for all optical line terminal (OLT) modules installed in the device. The PON network topology table is labeled by 4-byte indexes according to a simple network management protocol (SNMP).

### CLAIM OF PRIORITY

This application claims priority under 35 U.S.C. § 119 to an application entitled “Method of Restoring Setting Values by Managing PON Network Topology Table in Device Accommodating Plurality of EPON Ports,” filed in the Korean Intellectual Property Office on Feb. 22, 2005 and assigned Serial No. 2005-14671, the contents of which are incorporated herein by reference.

### BACKGROUND OF THE INVENTION

1. Field of the Invention

The present invention relates generally to a device for managing a plurality of Ethernet passive optical network (EPON) ports, and in particular, to a method of representing a network topology as a simple network management protocol (SNMP) index and automatically restoring setting values using the SNMP index.

2. Description of the Related Art

A simple network management protocol (SNMP) is a set of protocols for managing a network. For example, each device is provided with SNMP and an SNMP server has the entries of all devices in a network. The SNMP server transmits identification information to an SNMP client when each device is started. In this way, a table can be generated and available communications partners can be detected by explicit routing. The SNMP, such as relevant standards describing Management Information Base (MIB) and Structure for Management Information (SMI), enables systems to have a simple and operable structure to manage Transfer Control Protocol/Internet Protocol (TCP/IP)-based internets.

### SUMMARY OF THE INVENTION

The present invention provides a method of restoring setting values described above by managing a PON network topology table in a device configured to manage a plurality of EPON ports.

One aspect of the present invention is to provide a method of restoring setting values by managing a PON network topology table, in which previously set values can be automatically restored for the same entity by managing a table mapping MAC addresses to 4-byte indexes in a device managing a plurality of OLT modules and ONUs.

According to another aspect of the present invention, there is provided a method of restoring setting values by managing a passive optical network (PON) network topology table in a device accommodating a plurality of Ethernet passive optical network (EPON) ports, the method comprising the steps of: booting the device accommodating a plurality of EPON ports; a controller for restoring a previously set configuration and PON network topology table from a backup memory of the device; and performing a module initialization operation for all optical line terminal (OLT) modules installed in the device, wherein the PON network topology table is labeled by 4-byte indexes according to a simple network management protocol (SNMP).

According to another aspect of the present invention, there is provided a method of restoring setting values by managing a passive optical network (PON) network topology table in a device accommodating a plurality of Ethernet passive optical network (EPON) ports when a predetermined optical line terminal (OLT) module is installed in the device, the method comprising the steps of: (a) acquiring an EPON media access controller (MAC) address of the installed predetermined OLT module; (b) comparing the acquired MAC address to a previous MAC address using a current PON network topology table; (c) if the MAC addresses are the same in step (b), maintaining all setting values and topology and performing a provision of the installed predetermined OLT module; (d) after the provision step (c), obtaining a list of links discovered by inquiring logical links connected to the predetermined OLT module and performing a link discovery operation for all the discovered logical links; (e) if the MAC addresses are different from each other in step (b), initializing all setting values and topology and performing provisioning of the installed predetermined OLT module; and (f) after the provision step (e), obtaining a list of links discovered by inquiring logical links connected to the predetermined OLT module and performing the link discovery operation for all the discovered logical links, wherein the PON network topology table is labeled by 4-byte indexes according to a simple network management protocol (SNMP).

According to another aspect of the present invention, there is provided a method of restoring setting values by managing a passive optical network (PON) network topology table in a device accommodating a plurality of Ethernet passive optical network (EPON) ports when a logical link is added to the device accommodating a plurality of EPON ports, the method comprising the steps of: (a) acquiring an EPON media access controller (MAC) address of an optical network unit (ONU) corresponding to the logical link and a MAC address of the logical link; (b) restoring a previous index corresponding to the MAC address acquired in step (a) from the PON network topology table and determining whether the index exists; (c) if the index exists in step (b), maintaining the index, all setting values, and the PON network topology table and performing a provision of the ONU and the logical link; and (d) if the index does not exist in step (b), initializing the setting values by assigning a new index to the ONU and the logical link and performing a provision of the ONU and the logical link using the initialized setting values, wherein the PON network topology table is labeled by 4-byte indexes according to a simple network management protocol (SNMP).

### BRIEF DESCRIPTION OF THE DRAWINGS

The above features and advantages of the present invention will become more apparent from the following detailed description when taken in conjunction with the accompanying drawings in which:

FIG. 1 is a block diagram of a network topology accommodating a plurality of EPON ports according to an embodiment of the present invention;

FIG. 2 is a flowchart of a method of restoring setting values by managing a PON network topology table in a device accommodating a plurality of EPON ports according to an embodiment of the present invention;

FIG. 3 is a flowchart of a method of restoring setting values by managing a PON network topology table in a device accommodating a plurality of EPON ports according to the embodiment of the present invention; and

FIG. 4 is a flowchart of a method of restoring setting values by managing a PON network topology table in a device accommodating a plurality of EPON ports according to another embodiment of the present invention.

### DETAILED DESCRIPTION

Embodiments of the present invention will be described herein below with reference to the accompanying drawings. For the purposes of clarity and simplicity, well-known functions or constructions are not described in detail as they would obscure the invention in unnecessary detail.

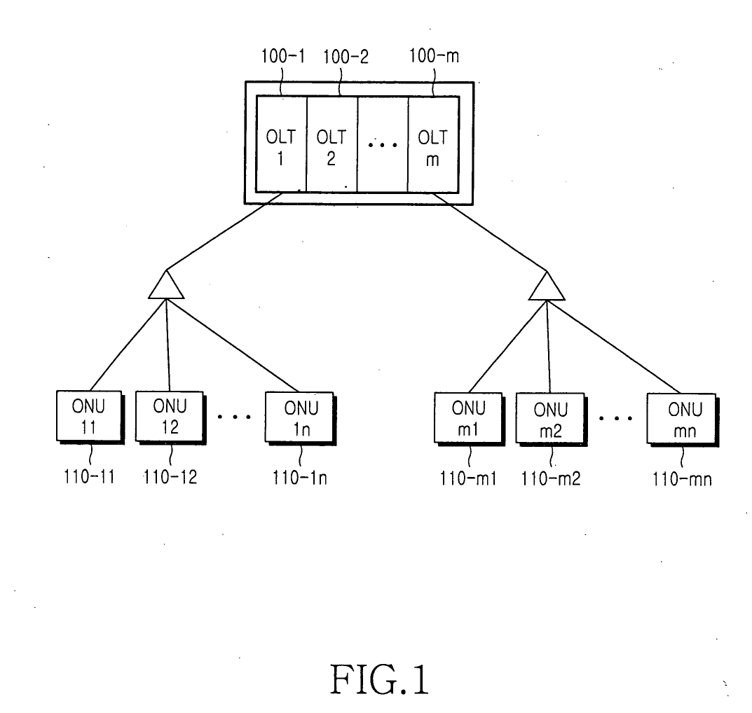

FIG. 1 is a block diagram of a network topology including a plurality of Ethernet passive optical network (EPON) ports and whereto the embodiment of the present invention is applicable.

Referring to FIG. 1, the network topology accommodating a plurality of EPON ports includes a plurality of optical line terminal (OLT) modules 100-1 to 100-m and a plurality of optical network units (ONUs) 110-11 to 110-1m and 110-m1 to 110-mm coupled to the OLT modules 100-1 to 100-m.

The OLT modules 100-1 to 100-m represent subsystems located between users and a service node to receive data from an upper network, perform electro-optic conversion, and transmit a multiplexed optical signal, and the ONUs 110-11 to 110-1m and 110-m1 to 110-mm represent user end devices to transmit information received from the OLT modules 100-1 to 100-m to the users.

To manage a network having the network topology as described above, it is necessary to index each device to a 4-byte index value using a simple network management protocol (SNMP). However, in the prior art, each device is identified by a 6-byte media access controller (MAC) address.

In the present invention, when the network topology illustrated in FIG. 1 exists, a PON network topology table is formed for each entity constructing a relevant network.

More specifically, the PON network topology table is classified into three tables “topoOltPortTable,” “topoOnuPortTable,” and “topoOnuLinkTable,” each table formed by Management Information Base (MIB) according to the SNMP as illustrated in Table 1 to Table 9.

TABLE 1
topoOltPortTable OBJECT-TYPE
SYNTAX SEQUENCE OF TopoOltPortEntry
ACCESS not-accessible
STATUS current
DESCRIPTION “This table contains one row per OLT physical port”

TABLE 2

topoOltPortEntry OBJECT-TYPE
SYNTAX TopoOltPortEntry
ACCESS not-accessible
STATUS current
DESCRIPTION “Information about a particular OLT Port”
INDEX { topoOltPortIndex }
::= { topoOltPortTable 1 }

TABLE 3

TopoOltPortEntry ::= SEQUENCE {
topoOltPortIndex INTEGER,
topoOltPortPhysicalAddr MacAddress,
topoOltPortContainedSlot INTEGER,
}

TABLE 4
topoOnuPortTable OBJECT-TYPE
SYNTAX SEQUENCE OF TopoOnuPortEntry
ACCESS not-accessible
STATUS current
DESCRIPTION “This table contains one row per ONU physical port”

TABLE 5

topoOnuPortEntry OBJECT-TYPE
SYNTAX TopoOnuPortEntry
ACCESS not-accessible
STATUS current
DESCRIPTION “Information about a particular ONU Port”
INDEX { topoOnuPortIndex }
::= { topoOnuPortTable 1 }

TABLE 6

TopoOnuPortEntry ::= SEQUENCE {
topoOnuPortIndex INTEGER,
topoOltPortPhysicalAddr MacAddress,
topoOltPortConnectedOlt INTEGER,
}

TABLE 7
topoOnuLinkTable OBJECT-TYPE
SYNTAX SEQUENCE OF TopoOnuLinkEntry
ACCESS not-accessible
STATUS current
DESCRIPTION “This table contains one row per ONU Logical Link”

TABLE 8
topoOnuLinkEntry OBJECT-TYPE
SYNTAX TopoOnuLinkEntry
ACCESS not-accessible
STATUS current
DESCRIPTION “Information about a particular ONU Logical Link”
INDEX { topoOnuLinkIndex }
::= { topoOnuLinkTable 1 }

TABLE 9

TopoOnuLinkEntry ::= SEQUENCE {
topoOnuLinkIndex INTEGER,
topoOnuLinkPhysicalAddr MacAddress,
topoOnuLinkContainedOnu INTEGER,
}

A method of restoring setting values by managing a PON network topology table according to the teachings of the present invention is performed by an OLT module initialization unit and a logical link discovery unit (a) when an OLT module is installed, (b) when an ONU is connected and therefore a logical link is registered, and (c) when the device accommodating a plurality of EPON ports is booted. Note that the OLT module initialization unit and the logical link discovery unit are an OAM software block in the system disclosed in FIG. 1. The logical link discovery unit assigns the logical position information of the ONU and performs restoring of the ONU configuration in the position information when it is registered. The OLT module initialization unit performs the function of restoring the OLT configuration in the physical position information of the OLT when the OLT module is installed in the devices, such as PC, VoIP-Phone and L2 switch linked to the ONUs.

When the device accommodating a plurality of EPON ports is booted, or when an OLT module is installed, both the OLT module initialization unit and the logical link discovery unit operate, and when a logical link is registered, only the logical link discovery unit operates.

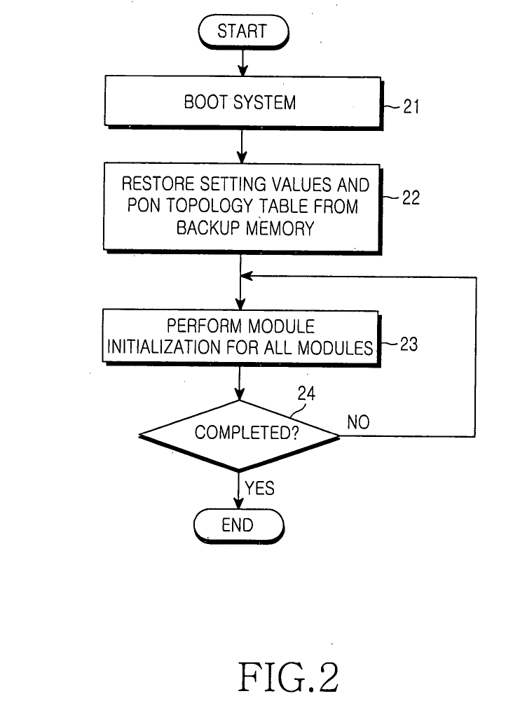

FIG. 2 is a flowchart of operation steps for restoring setting values by managing a PON network topology table according to the embodiment of the present invention.

The method of restoring setting values illustrated in FIG. 2 relates to an operation of software performing an operation, administration, and maintenance (OAM) function for restoring setting values when the device accommodating a plurality of EPON ports is booted.

As shown, when the device is booted in step 21, previously set configuration and PON network topology table are restored from a back up memory in step 22. The PON network topology table contains a MAC address and an index assigned to the MAC address as an entry.

Here, the configuration of EPON network topology table can be represented as intention codes, as follows:

| #define MAX_SLOT_NUM | 8 | //8 slots are existed in the device |
|---|---|---|
| #define MAX_OLT_PER-SLOT | 2 | //2 OLT Module are existed in one slot |
| #define MAX_ONU-PER-OLT | 32 | //32 ONU can be possible to register in one |
| | OLT Module | |
| #define MAX_LINK_PER_ONU | 4 | //maximum 4 links are accommodated in one |
| | ONU | |

| | |
|---|---|
| typedef struct { | |
| MAC_ADDR | macAddress; |
| Int | adminStatus; |
| Int | operStatus; |
| } PON_PORT_INFO; | |
| Typedefstruct { | |
| MAC_ADDR | macAddress; |
| Int | llid; |
| Int | adminStatus; |
| Int | operStatus; |
| } PON_PORT_INFO; | |
| Typedef struct{ | |
| PON_PORT_INFO | port; |
| PON_LINK_INFO | link[MAX_LINK_PER_OLT]; |
| ]PON_TOPOLOGY; | |
| PON_TOPOLOGY | ponTopology[MAX_SLOT_NUM]; |

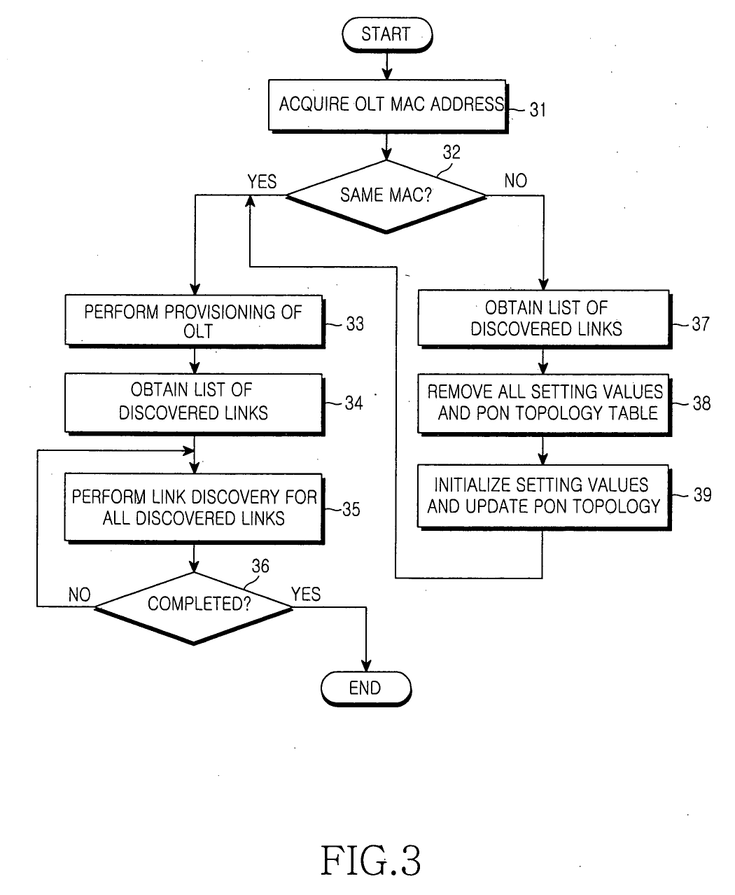

In steps 23 and 24, an initialization operation is performed for all OLT modules installed in the device as illustrated in FIG. 3.

FIG. 3 is a flowchart of restoring setting values by managing a PON network topology table according to the embodiment of the present invention.

The method of restoring setting values illustrated in FIG. 3 relates to a case where an OLT module is installed in the device accommodating a plurality of EPON ports. The term “setting values” indicates a class-map, a policy-map, and a rate-limit setting that a user sets in the ONU entity. It is managed as data construction and stored in a non-volatile memory in the case the user changes the setting values.

Referring to FIG. 3, as the module initialization operation is initiated, an EPON MAC address of the installed OLT module is acquired in step 31, and the acquired MAC address is compared to an existing MAC address using a current PON network topology table in step 32. That is, an index of the installed OLT module is determined by a physical position, i.e., a slot position, and the existing MAC address is inquired from the current PON network topology table using the slot position as a key value and compared to the MAC address of the installed OLT module.

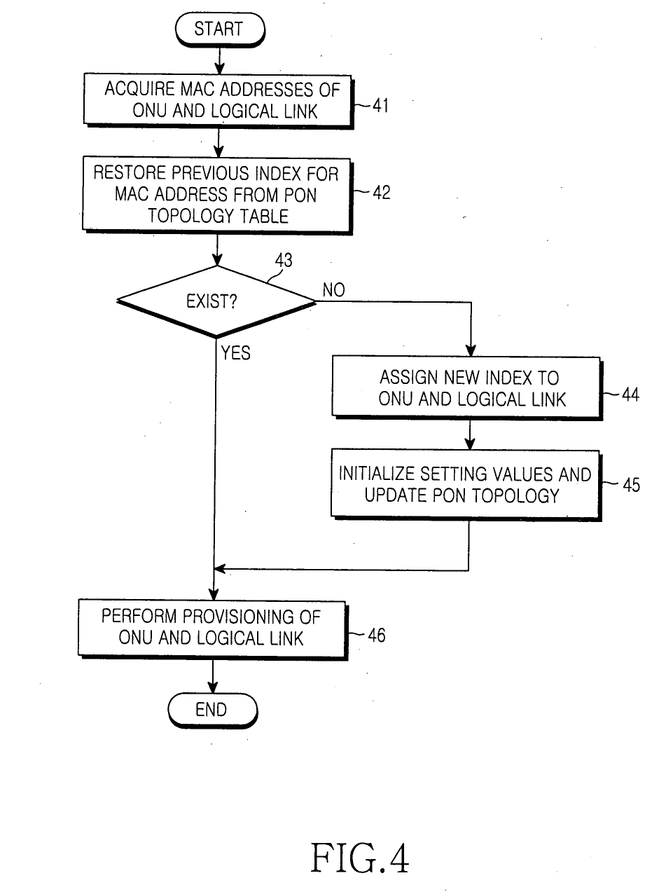

If the MAC addresses are the same, it indicates that the same OLT module as the previous is installed. Thus, all setting values and topology are maintained, and a provision of the installed OLT module is performed in step 33. In step 34, a list of links is discovered by inquiring logical links connected to the installed OLT module. In steps 35 and 36, a link discovery operation is performed for all the discovered links. The link discovery operation will be described in detail later with reference to FIG. 4.

If the MAC addresses are different from each other in step 32, it indicates that an OLT module different from the previous is installed. Thus, in step 37, a list of links is discovered by inquiring logical links connected to the installed OLT module. In step 38, all setting values and the PON network topology table are removed. In step 39, all setting values are initialized to default values, and the PON network topology is updated according to the acquired MAC address. That is, an OLT entry is changed to the MAC address of the installed OLT module in a PON network topology table, all setting values are initialized to default values by removing all ONUs and logical link entries connected to the installed OLT module, and the PON network topology is updated according to the acquired MAC address.

Thereafter, in step 33, provisioning of the installed OLT module is performed. In step 34, a list of links is discovered by inquiring logical links connected to the installed OLT module. In steps 35 and 36, a link discovery operation is performed for all the discovered links. Again, the link discovery operation will be described in detail with reference to FIG. 4.

FIG. 4 is a flowchart of restoring setting values by managing a PON network topology table in a device accommodating a plurality of EPON ports according to another embodiment of the present invention.

The method of restoring setting values illustrated in FIG. 4 relates to the case where an ONU is connected and thus a logical link is registered.

Referring to FIG. 4, as the link discovery operation is initiated, an EPON MAC address of the ONU corresponding to the logical link and a MAC address of the logical link are acquired in step 41, and a previous index according to the acquired MAC address is restored from a current PON network topology table in step 42. Since the ONU and the logical link have no connection with a physical position unlike an OLT module, a previously assigned index is inquired using the acquired MAC address as a key value from the PON network topology table and restored.

If an index corresponding to the acquired MAC address exists in step 43, i.e., when the ONU is reconnected, the index, all setting values, and the PON network topology table are maintained, and a provision of the ONU and the logical link is performed in step 46.

If an index corresponding to the acquired MAC address does not exist in step 43, i.e., when a new ONU is connected, in step 44, a new index is assigned to the ONU and the logical link. In step 45, an entry is added to the PON network topology table, all setting values are initialized to default values, and the PON network topology is updated according to the acquired MAC address. In step 46, a provision of the ONU and the logical link is performed using the determined setting values.

The method of the present invention can be written as computer programs and can be stored in a computer readable recording medium (CD-ROM, RAM, floppy disks, hard disks, optical magnetic disks, etc.).

As described above, according to the embodiments of the present invention, by managing unique MAC addresses of entries without connection with physical positions using 4-byte indexes in a device accommodating a plurality of EPON ports, interoperability can be achieved using an element management system (EMS) and an SNMP, and a function of restoring previous setting values is provided, thereby convenient in the device operation side.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of restoring setting values by managing a passive optical network (PON) network topology table in a device accommodating a plurality of Ethernet passive optical network (EPON) ports, the method comprising the steps of:
(a) booting the device accommodating the plurality of EPON ports;
(b) restoring a previously set configuration and the PON network topology table from a backup memory of the device; and
(c) performing a module initialization operation for all optical line terminal (OLT) modules installed in the device,
wherein the PON network topology table is labeled by 4-byte indexes according to a simple network management protocol (SNMP).

2. The method of claim 1, wherein the PON network topology table contains a MAC address and an index assigned to the MAC address as an entry.

3. The method of claim 1, wherein the module initialization operation comprises the steps of:
(d) acquiring an EPON media access controller (MAC) address of the installed predetermined OLT module;
(e) comparing the acquired MAC address to a previous MAC address using a current PON network topology table;
(f) if the MAC addresses are the same in step (e), maintaining all setting values and topology and performing a provision of the installed predetermined OLT module; and
(g) obtaining a list of links discovered by inquiring logical links connected to the predetermined OLT module and performing a link discovery operation for all the discovered logical links.

4. The method of claim 3, wherein the module initialization operation comprises the steps of:
(h) if the MAC addresses are different from each other in step (e), initializing all setting values and topology and performing a provision of the installed predetermined OLT module; and
(i) obtaining a list of links discovered by inquiring logical links connected to the predetermined OLT module and performing a link discovery operation for all the discovered logical links.

5. The method of claim 3, wherein the link discovery operation comprises the steps of:
(j) acquiring an EPON media access controller (MAC) address of an optical network unit (ONU) corresponding to the logical link and a MAC address of the logical link;
(k) restoring a previous index corresponding to the MAC address acquired in step (j) from the PON network topology table and determining whether the index exists;
(l) if the index exists, maintaining the index, all setting values, and the PON network topology table and performing a provision of the ONU and the logical link; and
(m) if the index does not exist, initializing the setting values by assigning a new index to the ONU and the logical link and performing a provision of the ONU and the logical link using the initialized setting values.

6. The method of claim 4, wherein the link discovery operation comprises the steps of:
(j) acquiring an EPON media access controller (MAC) address of an optical network unit (ONU) corresponding to the logical link and a MAC address of the logical link;
(k) restoring a previous index corresponding to the MAC address acquired in step (j) from the PON network topology table and determining whether the index exists;
(l) if the index exists, maintaining the index, all setting values, and the PON network topology table and performing a provision of the ONU and the logical link; and
(m) if the index does not exist, initializing the setting values by assigning a new index to the ONU and the logical link and performing a provision of the ONU and the logical link using the initialized setting values.

7. A method of restoring setting values by managing a passive optical network (PON) network topology table in a device accommodating a plurality of Ethernet passive optical network (EPON) ports when a predetermined optical line terminal (OLT) module is installed in the device, the method comprising the steps of:
(a) acquiring an EPON media access controller (MAC) address of the installed predetermined OLT module;
(b) comparing the acquired MAC address to a previous MAC address using a current PON network topology table;
(c) if the MAC addresses are the same, maintaining all setting values and topology and performing a provision of the installed predetermined OLT module;
(d) after the provisioning of step (c), obtaining a list of links discovered by inquiring logical links connected to the predetermined OLT module and performing a link discovery operation for all the discovered logical links;
(e) if the MAC addresses are different from each other, initializing all setting values and topology and performing a provision of the installed predetermined OLT module; and
(f) after the provisioning of step (e), obtaining a list of links discovered by inquiring logical links connected to the predetermined OLT module and performing the link discovery operation for all the discovered logical links,
wherein the PON network topology table is labeled by 4-byte indexes according to a simple network management protocol (SNMP).

8. The method of claim 7, wherein the link discovery operation comprises the steps of:
(g) acquiring an EPON media access controller (MAC) address of an optical network unit (ONU) corresponding to the logical link and a MAC address of the logical link;
(h) restoring a previous index corresponding to the MAC address acquired in step
(g) from the PON network topology table and determining whether the index exists;
(i) if the index exists, maintaining the index, all setting values, and the PON network topology table and performing a provision of the ONU and the logical link; and
(j) if the index does not exist, initializing the setting values by assigning a new index to the ONU and the logical link and performing a provision of the ONU and the logical link using the initialized setting values.

9. A method of restoring setting values by managing a passive optical network (PON) network topology table in a device accommodating a plurality of Ethernet passive optical network (EPON) ports when a logical link is added to the device, the method comprising the steps of:
(a) acquiring an EPON media access controller (MAC) address of an optical network unit (ONU) corresponding to the logical link and a MAC address of the logical link;
(b) restoring a previous index corresponding to the MAC address acquired in step
(a) from the PON network topology table and determining whether the index exists;
(c) if the index exists, maintaining the index, all setting values, and the PON network topology table and performing a provision of the ONU and the logical link; and
(d) if the index does not exist, initializing the setting values by assigning a new index to the ONU and the logical link and performing a provision of the ONU and the logical link using the initialized setting values,
wherein the PON network topology table is labeled by 4-byte indexes according to a simple network management protocol (SNMP).
